(19) United States
(12) Patent Application Publication
(10) Pub. No.: US 2015/0054248 A1
(43) Pub. Date: Feb. 26, 2015

(54) SUSPENSION FOR A BICYCLE TRAILER OR PRAM

(71) Applicant: Zwei plus zwei GmbH, Koln (DE)

(72) Inventors: Roger STANISLOWSKI, Bremen (DE); Mehmet KOC, Koln (DE); Kabir Kumar BHANJA, Koln (DE); Thomas HÜTTNER, Koln (DE)

(21) Appl. No.: 14/469,108

(22) Filed: Aug. 26, 2014

(30) Foreign Application Priority Data
Aug. 26, 2013 (DE) 10 2013 109 230.6

(51) Int. Cl. B62K 27/06; B62K 27/00

(52) U.S. Cl. CPC B62K 27/06; B62K 27/003
USPC 280/204

(57) ABSTRACT

A wheel suspension is provided for a non-motorized vehicle, in particular a pram or a bicycle trailer designed to transport children, which features a chassis (1) and at least two wheels (8), which are each mounted on a wheel swing arm (11, 15). For each wheel swing arm (11, 15) at least one elastic element (21) is provided, whereby the wheel swing arm (11, 15) supports itself via the chassis (1). In order to provide a wheel suspension of this kind which is based on a simple construction and enables an optimum level of suspension and shock-absorption for the non-motorized vehicle: (a.) the elastic element (21) is made of at least one dimensionally stable flexible polyurethane foam material, and/or (b.) both wheel swing arms (11, 15) protrude laterally over the chassis (1) and can be pivoted past a lateral frame section (3, 4) of the chassis (1).

The invention relates to a wheel suspension for a non-motorised vehicle, in particular a pram or a bicycle trailer designed to transport children, which features a chassis and at least two wheels which are each mounted on a wheel swing arm, wherein for each wheel swing arm at least one elastic element is provided, by which the swing arm is supported via the chassis. The invention also concerns a bicycle trailer with a wheel suspension of this kind.

Developing a suspension for a bicycle trailer which is equally effective with low loads, e.g. with a baby as a passenger, as it is with a full load, e.g. with two six-year-old children and baggage, is technically demanding. This is particularly true in light of the fact that, as a rule, the vehicle load capacity for a bicycle trailer exceeds the tare weight of the bicycle trailer, wherein the vehicle load capacity can vary by more than the tare weight of the bicycle trailer. In order for a suspension to be able to operate at an optimum level, it must be adapted to the weight which is to be spring-suspended. The suspension should already respond at the lowest possible load, but at the same time must not bottom out at the maximum load. If the spring is soft, the suspension is ideal for a baby to be transported, for example, but the bicycle trailer bottoms out at full load. If the spring is hard, the bicycle trailer no longer bottoms out at full load, but the suspension system is ineffective for the baby, since the spring does not yet respond at a low weight. The ideal situation is when a spring responds sensitively at a low load but still has a range of spring at maximum load and does not bottom out. In order to resolve this problem, suspension systems in bicycle trailers provide a weight-dependent adjustment of the spring rate. Making the correct adjustment for every journey is, however, relatively complex and inconvenient. Experience has shown that the average user of a bicycle trailer of this kind usually adjusts a spring only once to a relatively hard setting and keeps this setting thereafter, even if it is not ideal for the range of load situations.

In a well-known lightweight-design bicycle trailer, the Cougar model from the Canadian brand Chariot®, the structure consists of a chassis, on which the wheels are suspended and to which the shaft is fixed, and a passenger cabin, which is borne by the chassis. The chassis is essentially composed of two longitudinal beams, which are connected to one another in their middle area by two cross members. In the front section as well as the rear section, the frame elements of the passenger cabin are suspended in an articulated manner between the beams, wherein the passenger cabin can be folded over the chassis. This bicycle trailer is spring-loaded. For this purpose, at each rear end of the longitudinal beams a two-part flat spring is provided, on the free rear end of each a wheel is mounted. The flat springs are clamped to the longitudinal beams with a mounting device. On each of the flat springs, a lockable and adjustable clamping device is provided, with which the degree of elasticity of the flat springs can be adjusted. The design principle of this suspension is set out in DE 202 19 545 U1. This adjustable suspension has proved itself over many years. It is, however, comparatively expensive to manufacture, and the attenuation of the wheel suspension is limited to friction effects between the spring leaves and the flat springs. When the suspension is set to ‘soft’, the entire load is only received by one spring leaf, and, in this case, vibration damping is not attained. A further disadvantage is that the adjustment elements corrode with normal use due to the effects of the weather, in such a way that the adjusting screws in particular can no longer be moved, rendering it impossible to adjust the spring rate.

Another suspension possibility is laid out in DE 10 2007 026 087 A1. The wheels of the bicycle trailer outlined therein are mounted on a wheel mount which is fixed to the bicycle trailer by means of a fixture device. The wheel mount is supported against the fixture device by a spring element made from elastomer designed to reduce shocks caused by road bumps. At the same time, the spring element features two side sections of different lengths arranged next to one another, of which the first, longer one operates in a supportive capacity with smaller loads and the second, shorter one operates in an additional supportive capacity with higher loads, namely if, because of the load acting, the longer one is pressed together by more than the difference in length of both sides. The characteristic line of this suspension is not adjustable.

In DE 10 2007 026 087 A1, further reference is made to known bicycle trailers which use an elastomer body, grouted between an axle and a frame of the trailer, as a spring element, thereby cushioning impacts. This type of suspension is also not adjustable.

The basic purpose of the invention, in contrast, is to provide a bicycle trailer of the type stated at the beginning, which is based on a simple construction and facilitates an optimal level of suspension and shock-absorption for the non-motorised vehicle.

In terms of wheel swing arms, leading link wheel swing arms, whose bearing on the chassis in the direction of travel lies behind the bearing of a wheel on its free end, is to be considered, as well as trailing link swing arms, whose bearing on the chassis in the direction of travel lies in front of the wheel bearing of the bearing borne by it.

In particular, it shall be understood here and in the following that ‘non-motorised vehicles’ are those whose ratio between vehicle mass and standard vehicle load capacity weight lies in the range of 0.5 to 6, in particular in the range of 0.8 to 5 or 1 to 5. If the tare weight of a bicycle trailer amounts to 15 kg, for example, and the weight of a child transported therein to 20 kg, the ratio of vehicle mass to standard vehicle load capacity comes to 1.3. Such vehicles are, in particular, bicycle trailers, joggers and/or prams.

A solution pursuant to the invention is to use an elastic element made from at least one dimensionally-stable flexible polyurethane foam material for the suspension and shock-absorption of the wheel swing arm. Special consideration should be given to Sylomer® and/or Sylodin® as flexible polyurethane foam materials, both materials of Getzner Werkstoffe GmbH, Bürs, Austria, wherein Sylomer® in particular has transpired to be especially suitable. The materials Sylomer® and Sylodin® are supplied as vibration-absorbent and sound-absorbent materials for structural engineering and railway construction, as well as for the vibration damping of machines. The flexible polyurethane foam materials supplied on the market under the Cellasto® brand by BASF are an alternative, albeit a less preferable one. Other flexible polyurethane foam materials with suspension and shock-absorption properties comparable to or even better than those offered by Sylomer® are of course likewise favoured. Should the elastic element consist of several different flexible polyurethane foam materials, they can, for example, form an interlocking mesh or be stuck together.

Flexible polyurethane foam materials are permanently dimensionally-stable and tolerant against short-term overloading, even to an extreme degree. They are weather-resistant, do not wear and contain no substances which are dangerous to health. No maintenance or upkeep is necessary.

A property particular to the stated flexible polyurethane foam materials is their large impact on suspension and shock absorption, wherein the spring characteristic curve is progressive in at least one relevant section. At low pressure due to low weight or upon light impact, the PU soft foam is soft and smoothly compresses. At high pressure, the PU soft foam is more strongly compressed and becomes stiffer. Bottoming out is not to be expected at the forces usual for the operation of the non-motorised vehicle. As a consequence, it is possible to facilitate a good level of suspension for the vehicle at both lower and higher loads. At the same time, the stated flexible polyurethane foam materials do not snake, but feature a high self-damping level, leading to the swift depletion of oscillation energy and a high level of vibration isolation.

For this reason, the solution according to the invention facilitates a suspension and shock-absorption system whose vibration damping effect on the vehicle load capacity, in particular on the passengers sitting therein, is just as effective at a vehicle mass to vehicle load capacity ratio of 0.5 to 0.8 as it is at a ratio of 3 to 6, without requiring the suspension and shock-absorption system to be adjusted according to the load.

Subject to the forces applied to the spring element by the wheel swing arm and the compression path put aside in the process, ideally, flexible polyurethane foam materials with a density of 100 to 900 kg/m³, in particular a density of 250 to 600 kg/m3, are to be considered.

Therefore, by using an elastic element compliant with the invention, it is possible to provide every wheel suspension with optimum shock-absorption as well as optimal suspension, which is just as effective for a single infant or baby weighing 10 kg to be transported in the vehicle as it is for two six-year-olds with a combined weight of about 45 kg, with no weight-related adjustment required.

Particularly dangerous to health for human vibrations are stochastic stimulations in the frequency band between 10 and 20 Hz caused by travelling over large obstacles at high speed (e.g. potholes) with relatively high acceleration values, such as those arising when travelling over a cobblestone stretch of road. The successful reduction of these suspension pressures, especially for babies and toddlers, will only occur with a suspension system which features high levels of shock-absorption in this frequency band. In particular, the stated flexible polyurethane foam materials according to the invention feature a particularly high shock-absorption rate in this frequency range.

In a further solution according to the invention, both wheel swing arms stand laterally over and above the chassis, and can be pivoted outside past the lateral framework section of the chassis. It is thereby possible to set the spring-borne path of the wing arm constructively and unobstructedly, without having to change the design of the chassis as a result. In this way, it is possible to set the centre of gravity of the vehicle by an appropriate arrangement of the elastic element without an instant vertical restriction via the chassis. In particular, it is also possible to set the spring-borne path of the wheel swing arms in such a way that they run in a primarily horizontal direction when in a resting position, and the axles can occupy a position above and below the lateral framework section during the journey. Consequently, the spring-borne path of the wheel swing arms can also be established independent of the chassis. Particularly in conjunction with the use of elastic elements made from a flexible polyurethane foam material, this allows for the possibility of adjusting the suspension for the vehicle to an extremely comfortable level for the occupants to be transported.

In a preferred design of this solution according to the invention, the elastic element is held on a bearing element with a bearing surface which is primarily level in form and is arranged to slant to the horizontal plane. A level bearing surface has the advantage that forces transferred by the elastic element lying flat upon it are for the most part consistently absorbed across the bearing surface, meaning that the suspension and shock-absorbing effect of the elastic element can be optimally utilised. If the bearing surface is arranged in a slant to the horizontal plane, it is possible to adjust the wheel suspension in such a way that the wheel swing arms run primarily horizontally when in resting position. This is particularly advisable if the longitudinal axis of the wheel swing arm stands within an angle range of +/−12° to the horizontal plane in a resting position, particularly in a range of 0 to −12° for a leading link swing arm and 0 to 12° for a trailing link swing arm (angle specifications looking at the swing arm with a side view, clockwise). In both of the above-mentioned cases, the wheel axis lies in a resting position at the height of or slightly above the rotation axis of the swing arms. Thereby, the lever is greatest for vertical forces acting from the wheel to the wheel side arm, so that impacts in this location can be optimally absorbed.

In a preferred design of this solution according to the invention, in a resting position, the force acting on the elastic element resulting from the wheel swing arm acts at an oblique angle to the surface normals of the bearing surface, and the angle between the resulting force and the surface normals becomes smaller the greater the load. This means that when the load is increased, the elastic material is compressed over a wide surface parallel to the bearing surface, and the elastic element becomes stiffer as a result. This is particularly true if the elastic element is comprised of a flexible polyurethane foam material.

A further preferred design of this invention is characterised in that the bearing element is fixed to the lateral framework segment of the chassis. If the bearing element is not composed of the framework segment itself, the advantage arises that the position and orientation of the bearing surface can be selected independent of the geometry of the lateral framework segment. In particular, it can also be positioned at the side of the chassis.

In a further design of the invention, the bearing element can be fixed in different positions in the longitudinal direction on the lateral framework segment. As a result, the leverage ratio of the rotation axis of the wheel swing arm and elastic element to the elastic element and axle can be adjusted. The resting position of the wheel swing arm can thereby be adjusted for different loads of the vehicle. Admittedly, this is not necessary when elastic elements made from flexible polyurethane foam material are used, but can nevertheless be utilised for the optimal adjustment of the suspension and shock-absorption properties of the wheel suspension.

Regardless of the adjustability of the position of the bearing element on the chassis, it has transpired that particularly strong suspension and shock-absorption properties at an appropriate elastic element are attained if the leverage ratio of the distance between an axle of the wheel mounted at a wheel swing arm and the rotation axis of the wheel swing arm to the shortest distance between the elastic element lying flat against the wheel swing arm and the rotation axis of the wheel swing arm lies within a range of 3:1 to 7:1, ideally within a range of 4:1 to 6:1, and in particular at approximately 5:1.

The elastic element composed of PU soft foam can preferably be designed in such a way that its strain in a resting position of the wheel swing arm amounts to approximately 15 to 35% and approximately 50 to 70% at the expected peak load. A high comfort level during travel for the persons to be transported can be expected with a construction of this type.

The elastic element consisting of a flexible polyurethane foam material is preferably to be realised as pane-like with an essentially constant thickness. This has, in particular, production technical advantages, since the material is manufactured in mats of consistent thickness. In doing so, the elastic element is particularly arranged in such a way that the direction of its thickness runs transverse to the direction of compression.

Furthermore, by preference, the elastic element features no recesses, if need be with the exception of clearance holes for attachment purposes, and in this respect consists of a solid material.

By preference, the cross-section of the unstressed elastic element consisting of a flexible polyurethane foam material varies in the direction of compression. In a preferred embodiment, the shape of the elastic element comprised of a flexible polyurethane foam material, if need be with the exception of its exterior surface resting on the bearing surface, is curved in a circumferential direction, and it is particularly preferred that its approximate shape is that of a pitch circle or a pitch oval. Consequently, this means that with increasing pressure, a greater volume of space of the elastic element is compressed by the wheel swing arm. The incline of the spring characteristic curve of the elastic element can thereby be determined progressively subject to the attached load. If a quadrilateral or polygonal shape is used for the elastic element, the spring characteristic curve can likewise be determined subject to the load, but with the possible disadvantage that the spring characteristic curve does not alter progressively with increasing load, provided that the volume of space of the elastic element to be compressed with increasing load does not continually change.

Using an elastic element with a curved shape can be advantageous if the contact surface of the wheel swing arm connected with the elastic element features a concave bend, the curvature of which is lower than that of the contact surface of the elastic element converging with it. Hereby, the weight-dependent position and size of the contact surface between the elastic element and the wheel swing arm can be favourably influenced.

In a constructively simple design, the bearing element for the elastic element formed of a flexible polyurethane foam material, in particular executed in a pane-like fashion, is provided with lateral walls which partially surround the elastic element on opposite lateral surfaces. Moreover, at least one bolt for securing the elastic element is provided, which is retained on both opposite lateral walls and is directed through a clearance hole in the elastic element. Thereby, it is a particular advantage if the clearance hole in the elastic element is an elongated hole, which extends lengthways primarily in the direction of the forces working on the elastic element, in particular in the direction of the surface normals of the bearing surface. This avoids a situation wherein the free compression path of the elastic element is reduced by the bolt(s).

In a further design of the solutions according to the invention, the wheel swing arms are connected to one another by a common axle. Due to the rigid connection of both wheel swing arms, the rolling motions of the chassis (low tendency to pitch) can be reduced to a certain degree, especially when travelling quickly around turns or when travelling over an obstacle one-sidedly, and returning to a resting position becomes a faster process, which has a stabilising effect on travel, thereby constituting a gain in security in terms of active driving safety. In doing so, the movement of the wheel swing arms can be coupled especially well with an axle which features a profiled cross-section, on the ends of which the wheel swing arms are fitted with the corresponding profiled recesses. In comparison to round rubes, profiled tubes have the advantage of being able to better carry the torsional moment. Axes of a so-called cloverleaf tube are particularly preferable.

Besides the particular suspension and shock-absorption properties, the wheel suspension according to the invention features a further crucial advantage in that it is feasible with only three elements, namely a wheel swing arm, an elastic element and a bearing for the elastic element.

The device is explained in more detail hereinafter by reference to figures in which a favoured implementation example of the device is depicted.

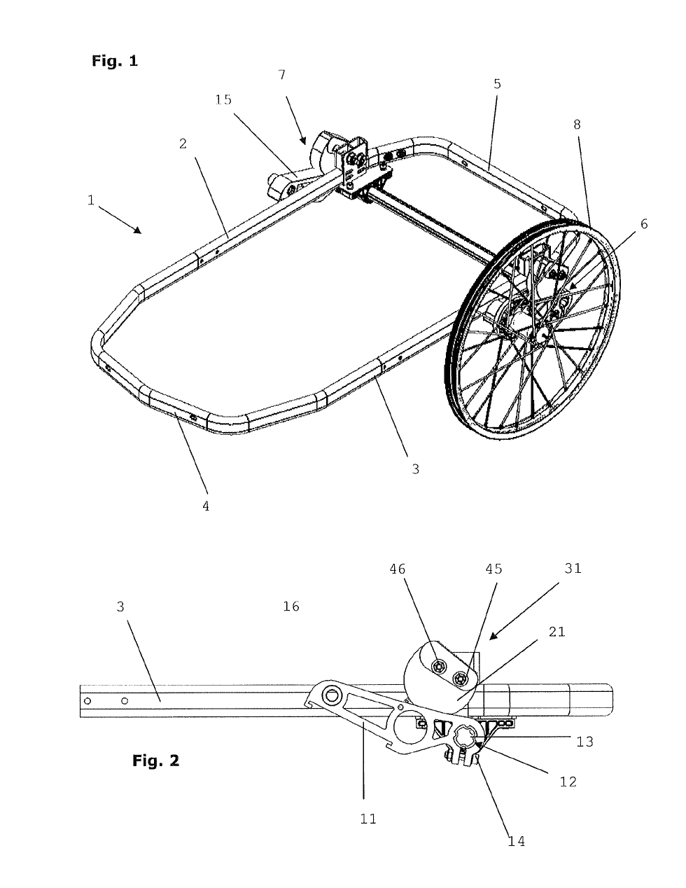

FIG. 1 shows an isometric view of a chassis of a bicycle trailer with a wheel suspension according to the invention from the front side;

FIG. 2. shows a lateral view of a section of the chassis illustrated in FIG. 1;

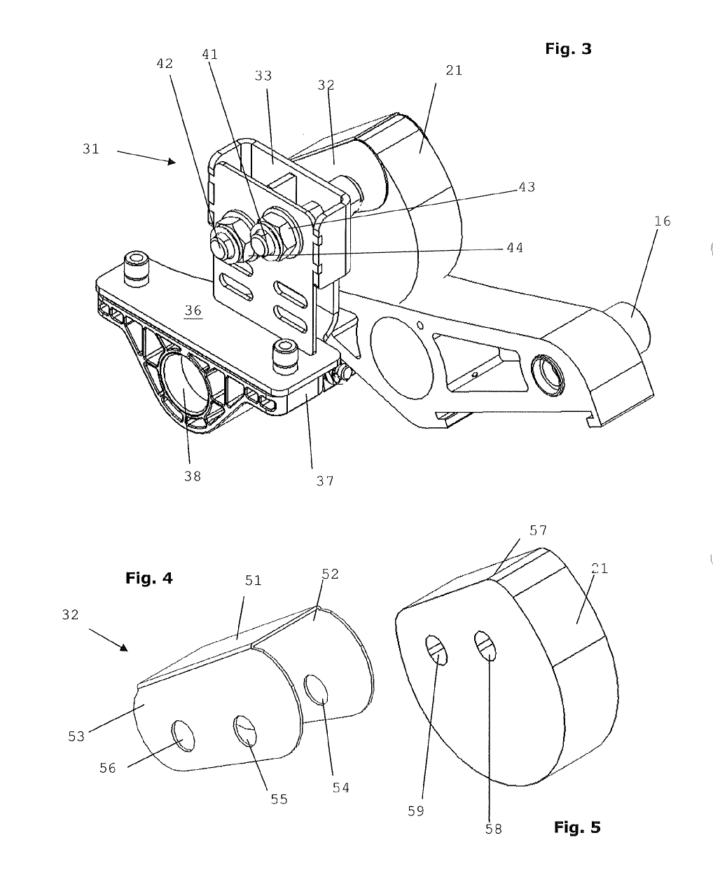

FIG. 3. is an isometric view of the wheel suspension according to the invention of the chassis portrayed in FIG. 1 from inside;

FIG. 4. is an isometric view of the bracket for an elastic element of the wheel suspension depicted in FIGS. 1 to 3; and

FIG. 5. is an isometric view of the elastic element of the wheel suspension portrayed in FIGS. 1 to 3.

FIG. 1 shows important sections of a chassis 1 or undercarriage of a bicycle trailer according to the invention. The chassis 1 features two lateral framework sections 2,3 running lengthways to the bicycle trailer, a framework section 4 at the front in direction of travel and running transverse to it, as well as a framework section 5 at the back in direction of travel and running transverse to it.

Wheel suspensions 6,7 are mounted in the area of the back ends of the lateral framework sections 4,5, to which suspensions the wheels 8 (only one is shown) of the bicycle trailer can be attached.

In FIGS. 2 and 3, the important parts of the wheel suspension 6 are shown. The wheel suspension 6 comprises a leading link swing arm 11, which is attached to an axle tube 13 at one of its ends with a recess 12 and thereto clamped with screws 14. In the illustrated execution example, the axle tube 13 is implemented as a cloverleaf tube with a cloverleaf-style outer contour, wherein the outermost contour surfaces lie on a sphere. The profile of the recess 12 of the wheel swing arm 11 corresponds to this. The wheel swing arm 11 is rigidly connected to the wheel swing arm 15 (see FIG. 1) by the axle tube 13 on the opposite side of the chassis 1. At the other end, the wheel swing arm 11 features a bearing bush 16 for the reception of a wheel axle (not pictured).

The wheel swing arm 11 supports itself on the chassis 1 by means of an elastic element 21. For this purpose, the elastic element 21 is fixed to the lateral framework section 3 by a mounting device 31.

The mounting device 31 features, among others, a bearing element 32, in which the elastic element 21 sits. In addition, a first and second mounting plate 33, 34 are provided, which are suited to completely encompass the lateral framework section 3, so that, if the mounting plates 33 and 34 are connected tightly to one another, they sit tightly on the lateral framework section 3. On the underside of the mounting plate 33 a one-piece, horizontal panel 36 connected thereto is provided. An axle tube carrier 37 is screwed onto the underside of the panel 36. In order to bear rotatably the axle tube 13, the axle tube carrier 37 features a bush or opening 38, whose shaft runs transverse to the direction of travel.

Two stud bolts 41, 42 operating as spring bolts are each inserted transversely through the elastic element 21, the bearing element 32 and the mounting plates 33 and 34 and screwed to their opposite ends with nuts 43, 44, 45, 46. Viewed in the direction of travel, they are arranged at an angle of approximately 40° side-by-side. The mounting device 31 is attached to the chassis 1 in a detachable fashion by the bolting, and can be relocated in a longitudinal direction if needed.

The bearing element 32 illustrated in FIG. 4 is comprised of a hole with a U-shaped cross-section whose base unit 51 is level in form and serves as a bearing surface for the elastic element 21. On the sides of the base unit 51, two lateral walls 52, 53 run parallel and transverse to it in order to laterally surround a section of the elastic element 21. Bore holes 54, 55, 56 are provided in the lateral walls 52, 53, through which the stud bolts 41, 42 are placed. All bore holes are equally spaced to the base unit 51, so that the bearing surface runs correspondent to the positioning of the stud bolts 41, 42 at an angle of approximately 40° to the lateral framework section 3.

FIG. 5 illustrates the elastic element. It has a consistent thickness and is formed with a level surface 57, with which the elastic element 21 lies flat against the bearing surface of the bearing element 32. Besides this, in a non-compressed state, the outer contour of the elastic element is almost circular. In the elastic element, clearance holes 58, 59 are provided for the stud bolts 41, 42. The clearance holes are formed as (albeit short) elongated holes, so that the elastic element can be compressed without the stud bolts 41, 42 operating as counter bearings and significantly shortening the spring deflection of the elastic element 21.

A flexible polyurethane foam material distributed under the brand name Sylomer®SR 450 has proved to be a particular suitable material for the elastic element. Suitable material thickness lies, for example, in the range of 12.5 to 25 mm.

The wheel suspension 7 is constructed accordingly on the opposite side of the chassis.

FIGS. 1 and 2 show the wheel swing arm 6 in a resting position, meaning in a position in which the bicycle trailer is unladen and stationary, and therefore exposed to only its tare weight, and is not exposed to any impacts due to surface irregularities in the road. The wheel swing arm 6 runs at an angle less than 10° to the horizontal plane (here tantamount to the orientation of the lateral framework section 3).

1. A wheel suspension for a non-motorized vehicle, comprising:
a chassis, including:
lateral framework sections running lengthways to the vehicle;
at least two wheels;
at least two respective wheel swing arms onto which the respective wheels are mounted; and
at least two respective elastic elements associated with the respective at least two wheel swing arms, such that a respective wheel swing arm supports itself via the chassis, and wherein a respective elastic element is comprised of at least one dimensionally-stable flexible polyurethane foam material.

2. The wheel suspension according to claim 1, wherein the at least one flexible polyurethane foam material is selected from the group consisting of Sylomer®, Sylodyn® and Cellasto®.

3. The wheel suspension according to claim 1, wherein the at least one flexible polyurethane foam material has a density of 100 to 900 kg/m³.

4. The wheel suspension according to claim 1, wherein the at least one flexible polyurethane foam material has a progressive spring characteristic curve in at least one section.

5. The wheel suspension according to claim 1, wherein the at least one flexible polyurethane foam material has a high shock-absorption rate in a frequency range of 10-20 Hz.

6. The wheel suspension according to claim 1, wherein a respective elastic element has a pane-like design having an essentially constant thickness.

7. The wheel suspension according to claim 1, wherein a cross-section of a respective elastic element, when not stressed, varies in a direction of compression, wherein a shape of the respective elastic element is curved in a circumferential direction, except its exterior surface resting on a bearing surface, and has an approximate shape of a pitch circle or a pitch oval.

8. The wheel suspension according to claim 7, wherein a contact surface of a respective one of the wheel swing arms connected with at least one elastic element associated with the respective one of the wheel swing arms has a concave bend, the curvature of which concave bend is lower than that of a contact surface of the at least one elastic element converging with the concave bend.

9. The wheel suspension according to claim 1, wherein at least one contact surface of the a respective elastic element, which is in contact with a bearing surface arranged on the chassis or with a bearing surface on a respective spring arm, is at least 10% smaller under a low load in a resting position than it is at an impact load.

10. A wheel suspension for a non-motorized vehicle, comprising:
a chassis;
at least two wheels;
at least two respective wheel swing arms onto which the respective wheels are mounted; and
at least two elastic elements associated with the respective at least two wheel swing arms, such that a respective wheel swing arm supports itself via the chassis,
wherein the wheel swing arms are arranged on a side of the chassis in such a way that they can each be pivoted past a lateral framework section of the chassis.

11. The wheel suspension according to claim 10, wherein at least one of the elastic elements is held on a respective bearing element with a bearing surface which is primarily level and is arranged to slant to a horizontal plane.

12. The wheel suspension according to claim 11, wherein in a resting position, a force acting on at least one of the elastic elements resulting from a respective wheel swing arm acts at an oblique angle to surface normals of the bearing surface, and an angle between a resulting force and the surface normals becomes smaller, the greater the load.

13. The wheel suspension according to claim 11, wherein the bearing element is attached to a lateral framework section of the chassis.

14. The wheel suspension according to claim 13, wherein the bearing element is enabled to be fixed in different positions in a longitudinal direction on the lateral framework segment.

15. The wheel suspension according to claim 11, wherein the bearing element partially surrounds the elastic element on opposite lateral surfaces with lateral walls, and
wherein the wheel suspension further comprises at least one bolt arranged to secure the elastic element, wherein the at least one bolt is arranged to be retained on both opposite lateral walls and to be directed through a clearance hole in the elastic element.

16. The wheel suspension according to claim 15, wherein the clearance hole in the elastic element is an elongated hole, which extends lengthways primarily in a direction of the forces working on the elastic element.

17. The wheel suspension according to claim 1, wherein the wheel swing arms are connected to one another by a common axle.

18. The wheel suspension according to claim 17, wherein the axle has a profiled cross-section, on ends of which the wheel swing arms are fitted with corresponding profiled recesses.

19. The wheel suspension according to claim 1, wherein a leverage ratio of a distance between an axle of a respective wheel mounted to a respective wheel swing arm and a rotation axis of the respective wheel swing arm to a shortest distance between a respective elastic element lying flat against the respective wheel swing arm and the rotation axis of the respective wheel swing arm lies within a range of 3:1 to 7:1.

20. A bicycle trailer including the wheel suspension according to claim 1.
